(19) United States
(12) Patent Application Publication
(10) Pub. No.: US 2025/0104465 A1
(43) Pub. Date: Mar. 27, 2025

(54) COLLECTION METHOD, COLLECTION DEVICE, AND ELECTRONIC DEVICE

(71) Applicant: Lenovo (Beijing) Limited, Beijing (CN)

(72) Inventors: Jinbing LIANG, Beijing (CN); Tongbin JU, Beijing (CN)

(21) Appl. No.: 18/882,735

(22) Filed: Sep. 11, 2024

(30) Foreign Application Priority Data
Sep. 27, 2023 (CN) 202311265921.6

(51) Int. Cl. G06V 40/12; G06V 10/10; G06V 10/75; G06V 40/60

(52) U.S. Cl. CPC G06V 40/1335; G06V 10/16; G06V 10/751; G06V 40/67

(57) ABSTRACT

A collection method includes obtaining, through a collection area of a collection device, a plurality of collected images based on one or more target configuration parameters. The one or more target configuration parameters, when applied to the collection device, enable the collection device to obtain an image that meets a clarity condition when an operation body moves in the collection area. The method further includes determining target collected images based on the plurality of collected images, and generating a template for biometric verification of the operation body by splicing the target collected images.

### CROSS-REFERENCE TO RELATED APPLICATION

This application claims priority to Chinese Patent Application No. 202311265921.6, filed on Sep. 27, 2023, the entire content of which is incorporated herein by reference.

### TECHNICAL FIELD

The present disclosure generally relates to the field of electronic technologies and, more particularly, to a collection method, a collection device, and an electronic device.

### BACKGROUND

At present, electronic devices may use biometric verification functions for payment, log-in or unlocking, etc. Before implementing the biometric verification function, an electronic device is usually required to collect biometrics based on a collection area and generate a complete biometric template based on the collected biometrics, such that the biometric verification function can be implemented based on the generated biometric template. However, if the collection area is relatively small, during biometrics collection, the user needs to press an operation body on the collection area a plurality of times (i.e., performing a plurality of input operations) to allow the electronic device to obtain the biometric information. This entry method results in low efficiency in biometric entry.

### SUMMARY

In accordance with the present disclosure, there is provided a collection method including obtaining, through a collection area of a collection device, a plurality of collected images based on one or more target configuration parameters. The one or more target configuration parameters, when applied to the collection device, enable the collection device to obtain an image that meets a clarity condition when an operation body moves in the collection area. The method further includes determining target collected images based on the plurality of collected images, and generating a template for biometric verification of the operation body by splicing the target collected images.

Also in accordance with the present disclosure, there is provided a collection device including a collection area and a collection component. The collection component is configured to obtain a plurality of collected images based on one or more target configuration parameters. The one or more target configuration parameters, when applied to the collection device, enable the collection device to obtain an image that meets a clarity condition when an operation body moves in the collection area.

Also in accordance with the present disclosure, there is provided an electronic device including a collection device and a processor configured to configure the collection device based on one or more target configuration parameters to obtain a plurality of collected images. The one or more target configuration parameters, when applied to the collection device, enable the collection device to obtain an image that meets a clarity condition when an operation body moves in the collection area. The processor is further configured to determine target collected images based on the plurality of collected images and generate a template for biometric verification of the operation body by splicing the target collected images.

### BRIEF DESCRIPTION OF THE DRAWINGS

FIG. 1 is a flow chart of a collection method consistent with the present disclosure.

FIG. 2 is a schematic diagram showing an application scenario of a collection method consistent with the present disclosure.

FIG. 3 is a flow chart of another collection method consistent with the present disclosure.

FIG. 4 is a schematic diagram showing a spiral movement consistent with the present disclosure.

FIG. 5 is a schematic diagram showing a sliding movement consistent with the present disclosure.

FIG. 6 is a flow chart of another collection method consistent with the present disclosure.

FIG. 7 is a schematic diagram showing an application scenario of the collection method in FIG. 4 consistent with the present disclosure.

FIG. 8 is a flow chart of another collection method consistent with the present disclosure.

FIG. 9 is a flow chart of another collection method consistent with the present disclosure.

FIG. 10 is a flow chart of another collection method consistent with the present disclosure.

FIG. 11 is a flow chart of another collection method consistent with the present disclosure.

FIG. 12 is a flow chart of another collection method consistent with the present disclosure.

FIG. 13 is a schematic structural diagram of an electronic device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

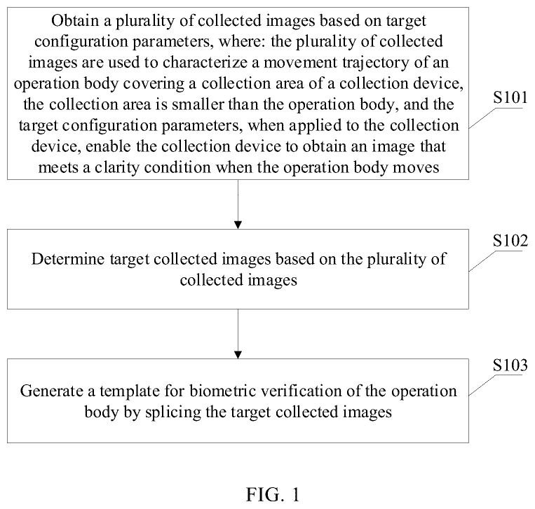

The present disclosure provides a collection method. The collection method may be applied to an electronic device. The present disclosure has no limit on the product type of the electronic device. In one embodiment shown in FIG. 1, the collection method includes S101 to S103.

At S101, based on target configuration parameters, a plurality of collected images are obtained, and the plurality of collected images are used to characterize a movement trajectory of an operation body covering a collection area of a collection device. The collection area may be smaller than the operation body, and the target configuration parameters, when applied to the collection device, may enable the collection device to obtain an image that meets a clarity condition when the operation body moves.

The collection device may include the collection area. The collection device may generate a collected image by collecting biometric features of the operation body acting on the collection area.

The collection device may be a device such as a fingerprint sensor that may be used to collect fingerprint information of a finger. Accordingly, the operation body may include but is not limited to a finger. Corresponding to the collection device which is a device that may be used to collect fingerprint information of a finger, the collection device may realize the collection of the fingerprint information and generate a corresponding fingerprint image by sensing the touch input of the finger in the collection area.

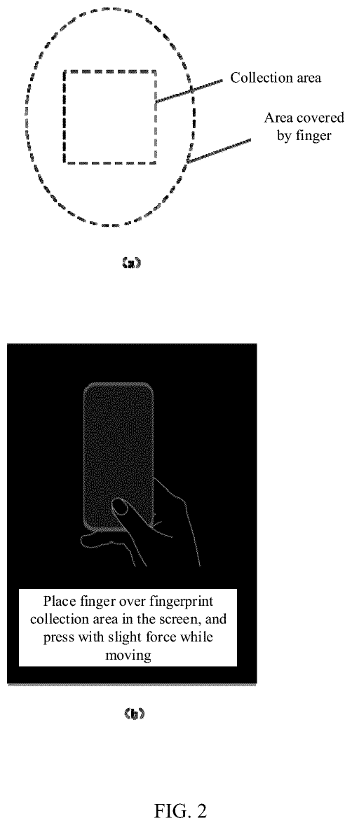

In one embodiment, the collection area may be smaller than the operation body. When the operation body acts on the collection area once and does not move, the collection device may collect a small amount of biometrics, and the recording speed may be slow. To speed up the recording speed, the electronic device may prompt the operation body to cover the collection area and move to perform biometric recording. For example, in one embodiment, when the operation body is a finger, as shown in FIG. 2(a), the collection area may be smaller than the coverage area of the finger. When the finger presses the collection area once, the collection device may collect the fingerprint information of a portion of the finger in the collection area, but may not be able to collect the fingerprint information of another portion of the finger that is not in the collection area. As shown in FIG. 2(b), a prompt message “Place finger over fingerprint collection area in the screen, and press with slight force while moving” may be given on the biometric recording interface to speed up the recording speed. The embodiment shown in FIG. 2 is used as an example only to illustrate the size relationship between the collection area and the operation body, and does not limit the size relationship between the operation body and the collection area.

Corresponding to the movement of the operation body, the target configuration parameters, when applied to the collection device, may enable the collection device to obtain an image that meets the clarity condition when the operation body moves, thereby obtaining the plurality of collected images.

At S102, target collected images are determined based on the plurality of collected images.

In one embodiment, the target collected images may be from the plurality of collected images, and may be collected images that may be used for splicing in the plurality of collected images.

At S103, the target collected images are spliced to generate a template for biometric verification of the operation body.

In one embodiment, when the number of the target collected images reaches a set number threshold, the template for biometric verification of the operation body may be generated based on splicing the target collected images.

S103 may include but is not limited to: splicing the target collected images to obtain a spliced image; and, when the area of the spliced image reaches a set area threshold, terminating the splicing to obtain the template for biometric verification of the operation body.

The set area threshold may be set as needed and is not limited in the present disclosure.

When the biometric verification of the operation body is required, the collection device may obtain an image for biometric verification. The template may be updated based on the image for biometric verification to improve the image quality of the template, when the image for biometric verification passes the verification of the template, and the image for biometric verification meets at least one of that the quality of the image for biometric verification is higher than the image quality of the template and the template of the input biometric or the image for biometric verification has more feature point than the template.

In the present disclosure, corresponding to the collection area that is smaller than the operation body, the operation body may cover the collection area and move to improve the efficiency of the collection device in collecting images, and obtain the plurality of collected images based on the target configuration parameters, to ensure that the plurality of collected images are images that meet the clarity condition. On the basis that the efficiency of image collection is improved and the images meet the clarity condition, the target collected images may be determined based on the plurality of collected images, and the target collected images may be spliced to generate the template for biometric verification of the operation body. Under the hardware configuration where the collection area is smaller than the operation body, the efficiency of biometric recording may be improved and the quality of the template may be guaranteed, thereby improving the user experience.

In one embodiment, S102 may include, but is not limited to, S1021 and S1022.

At S1021, images satisfying the clarity condition are selected from the plurality of collected images, and are determined as a target collected image.

It is understandable that, although the target configuration parameter acts on the collection device such that the images satisfying the clarity condition are able to be obtained when the operation body moves relative to the collection device, the collection device may obtain images that do not satisfy the clarity condition when the operation body moves too fast. To avoid using the images that do not satisfy the clarity condition for generating the template, the clarity of the plurality of collected images may be judged, and the images satisfying the clarity condition may be selected from the plurality of collected images.

At S1022, images satisfying a splicing feature condition are selected from the plurality of collected images, and are determined as the target collected image.

In one embodiment, for each collected images in the plurality of collected images, the feature point difference between the collected images and the previous collected images may be determined. And when the feature point difference meets the feature point difference threshold, the collected images may be determined as one target collected image.

The feature point difference threshold may be set as needed, and is not limited in the present disclosure.

In the present disclosure, the images satisfying the clarity condition may be selected from the plurality of collected images, and the images satisfying the clarity condition may be determined as a target collected image, which may ensure the clarity of the target collected images and ensure the quality of the template thereof. The images that meet the splicing feature condition may be selected from the plurality of collected images and the images that meet the splicing feature condition may be determined as a target collected image, which may ensure that the characteristics of the target collected images meet the splicing condition and ensure the quality of the template.

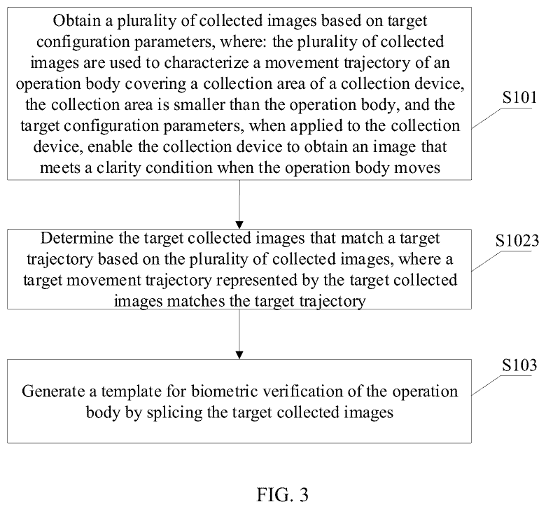

In another embodiment shown in FIG. 3, S102 may include, but is not limited to:

S1023: determining the target collected images that match the target trajectory based on the plurality of collected images. The target movement trajectory represented by the target collected images may match the target trajectory.

The target trajectory may be determined based on a specified area corresponding to the operation body and the target configuration parameters of the collection device, such that the collection device is able to obtain the plurality of collected images that meet the clarity condition within the collection duration when the operation body moves according to the target trajectory, and the area corresponding to the plurality of collected images that meet the clarity condition may not be less than the specified area corresponding to the operation body.

In one embodiment, the target trajectory may be determined based on the specified area corresponding to the operation body and the target configuration parameters of the collection device, by:
S11: determining the collection duration corresponding to the collection device based on the specified area corresponding to the operation body and the target configuration parameters of the collection device, where the area corresponding to the plurality of collected images collected by the collection device in the collection duration may not be less than the specified area and may meet the clarity condition; and
S12: determining the target trajectory based on the collection duration, the specified area, and a specified shape parameter.

For example, in one embodiment, the specified shape parameter may be the number of spiral turns. The radius of the spiral may be determined based on the collection duration and the specified area. The spiral intercept may be determined based on the radius of the spiral and the number of spiral turns, and the target spiral may be determined based on the number of spiral turns and the spiral intercept.

Corresponding to the implementation method in which the target trajectory is the target spiral, the length of the target spiral may be calculated based on the number of spiral turns, the spiral intercept and a numerical integration method, and the specified moving speed may be determined based on the length of the target spiral and the collection duration.

It may be understood that when the operation body moves according to the target trajectory, the operation body may move at the specified moving speed. When the operation body does not move according to the target trajectory, the operation body may not move at the specified moving speed. Once the moving speed of the operation body is faster than the specified moving speed, the collected images obtained by the collection device may not meet the clarity condition. Once the moving speed of the operation body is slower than the specified moving speed, the collection device cannot obtain the plurality of collected images that meet the clarity condition within the collection duration, and the area of the obtained a plurality of collected images may not reach the specified area corresponding to the operation body.

In the present embodiment, whether the moving speed of the operation body is faster or slower than the specified moving speed is determined by determining whether the collected images match the target trajectory, and the moving speed of the operation body may not be calculated.

The operation body may not move along the target trajectory at all times. When the operation body moves too fast and does not move along the target trajectory, the collected images obtained by the collection device may not meet the clarity condition. Therefore, the collected images matching the target trajectory may be determined from a plurality of collected images, and the collected images matching the target trajectory may be determined as a target collected image that meet the target trajectory, to obtain the collected images that meet the clarity condition.

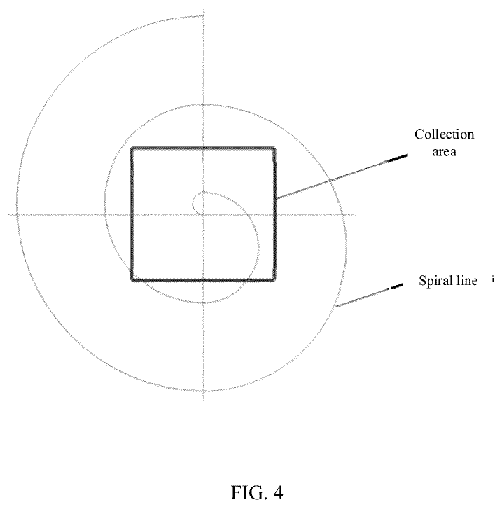

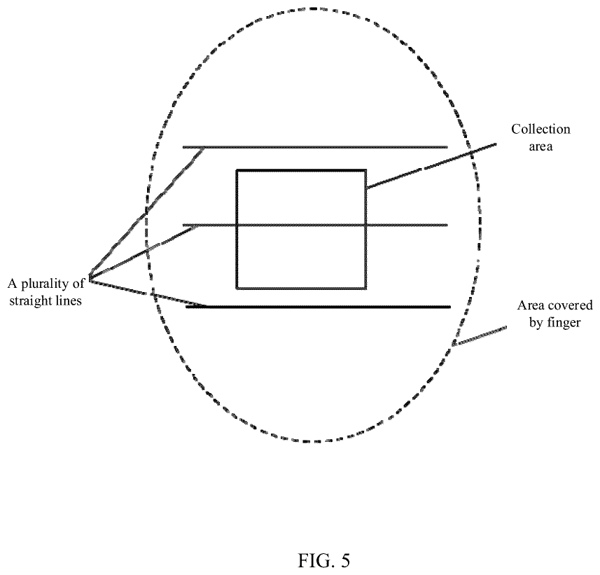

In the present disclosure, there is no limit on the shape of the target trajectory. For example, the target trajectory may include but is not limited to: a spiral line or a plurality of straight lines. When the target trajectory is a spiral line, as shown in FIG. 4, the operation body may cover the collection area and move along the spiral line, such that the collection device is able to collect complete biometric features at one time. When the target trajectory is a plurality of straight lines, as shown in FIG. 5, the operation body may cover the collection area and slide a plurality of times, such that the collection device is able to collect complete biometric features through a plurality of sliding movements. It may be understood that the operation body may stop pressing the contact area corresponding to the collection area at the end of each sliding movement, and may press the contact area corresponding to the collection again to slide when the sliding starts again.

The embodiments with the collection area, the spiral line, and a plurality of straight lines in FIG. 4 and FIG. 5 are used as examples only to illustrate target trajectories and the collection area, and they may not be displayed on the biometric feature entry interface in the present disclosure.

In the present disclosure, based on a plurality of collected images, the target collected images that match the target trajectory may be determined. The target collected images may be determined to be collected images obtained by the collection device when the operation body moves along the target trajectory, ensuring that the target collected images meet the clarity condition and further ensuring the quality of the template obtained by splicing the target collected images.

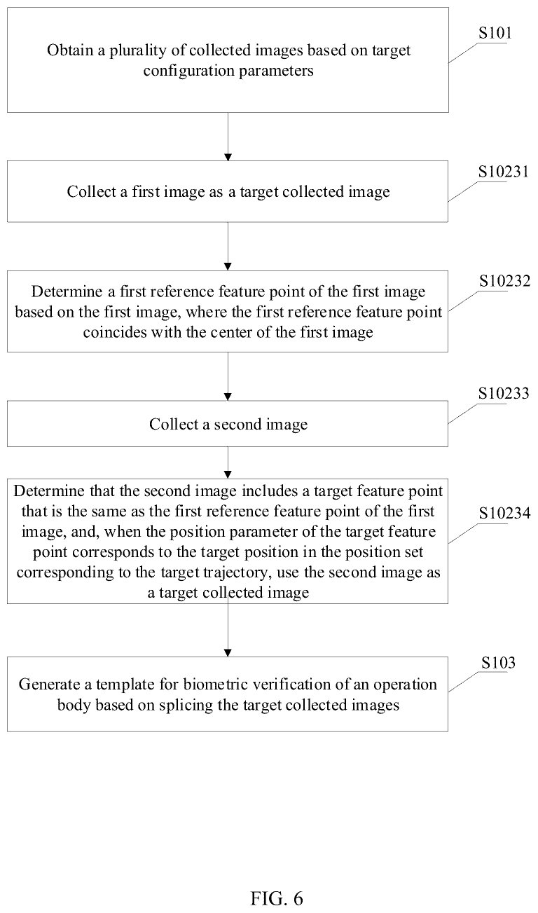

In another embodiment, as shown in FIG. 6, S1023 may include, but is not limited to S10231 to S10234.

At S10231, a first image is collected as a target collected image.

In one embodiment, a coordinate system may be established based on the center point of the collection area as the origin, and the starting point of the target trajectory may coincide with the origin of the coordinate system, such that the collected images obtained by the collection device and the target trajectory are in the same coordinate system.

The first image may be the first collected image obtained by the collection device based on the target configuration parameters, and the feature point corresponding to the center of the first image may match the starting point of the target trajectory. Since the feature point corresponding to the center of the first image matches the starting point of the target trajectory, the first image may be used as a target collected image.

In one embodiment, a fixed collection time interval may be set, and the timing may start every time an image is collected. When the timing reaches the collection time interval, a new image may be collected.

At S10232, a first reference feature point of the first image is determined based on the first image, and the first reference feature point coincides with the center of the first image.

In an image, the center of the image may be relatively easy to determine. Therefore, the center of the first image may be determined first, and a feature point of the center of the first image may be used as the first reference feature point.

At S10233, a second image is collected.

Timing may start from the collection of the first image. If the timing duration reaches the collection time interval, the second image may be collected. The second image is relative to the first image according to the timing duration. When the set duration threshold is greater than the duration for obtaining the collected images by the collection device based on the target configuration parameters, when the timing starts from the first image and the timing duration reaches the set duration threshold, the second image collected in this step may not be the second collected image obtained by the collection device. For example, if the duration of obtaining the collected images based on the target configuration parameters is 100 ms and the set duration threshold is 300 ms, when the timing duration reaches the set duration threshold, the collection device may have obtained three collected images, namely the first collected image, the second collected image, and the third collected image. The second image collected in this step may be the third collected image obtained by the collection device.

At S10234, that the second image includes a target feature point that is the same as the first reference feature point of the first image is determined based on the second image. When the position parameters of the target feature point correspond to the target position in the position set corresponding to the target trajectory, the second image may be determined as a target collected image.

The operation body may enter the biometric features by moving relative to the collection area. Different images obtained by the collection device may be different from each other. Therefore, it may be possible to determine whether the operation body is moving relative to the collection area by determining whether the two images are different from each other.

Determining whether the two images are different from each other may include, but is not limited to determining whether the second image includes a target feature point that is the same as the first reference feature point of the first image.

When it is determined that the second image includes the target feature point that is the same as the first reference feature point of the first image based on the second image, it may be determined that the operation body is moving relative to the collection area.

On this basis, it may be determined whether the position parameters of the target feature point correspond to the target position in the position set corresponding to the target trajectory. If they correspond, it may be determined that the second image matches the target trajectory, and the second image may be used as a target collected image.

The second image may match the target trajectory, and it may be determined whether the moving speed of the operation body relative to the collection area meets the specified moving speed. The collected images of the operation body moving at the specified moving speed obtained by the collection device may meet the clarity condition. Accordingly, the second image may meet the clarity condition.

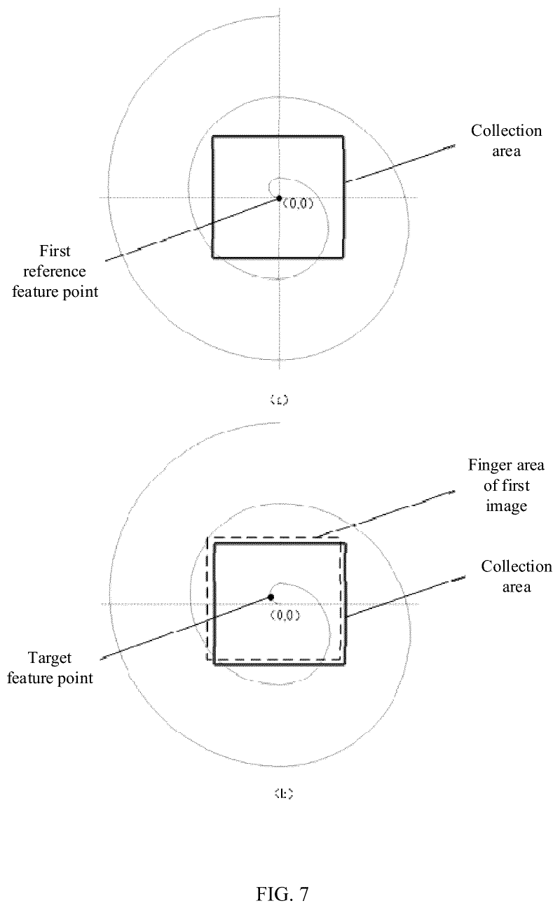

The position parameters of the target feature point may correspond to the target position in the position set corresponding to the target trajectory, which may include but is not limited to: the position parameters of the target feature point are consistent with the target position in the position set corresponding to the target trajectory. For example, in one embodiment, the target trajectory may be a target spiral line, and the operation body may be a finger. As shown in FIG. 7(a), the first reference feature point of the first image coincides with the center of the first image, and the coordinates of the center of the first image are the coordinates (0,0) of the center of the collection area. When the second image includes the target feature point that is the same as the first reference feature point of the first image, the relative position relationship between the finger area corresponding to the first image and the collection area is shown in FIG. 7(b). As shown in FIG. 7(b), since the collection area is fixed, the center of the second image still coincides with the center of the collection area, the position parameters of the target feature point are consistent with the target position in the position set corresponding to the target trajectory, the target feature point is located on the target spiral line, and the target feature point is offset relative to the center (0,0) of the collection area.

The position parameters of the target feature point may correspond to the target position in the position set corresponding to the target trajectory, which may include but is not limited to: the difference between the position parameters of the target feature point and the target position in the position set corresponding to the target trajectory satisfies a set position difference threshold.

Corresponding to the implementation method of establishing the coordinate system based on the center point of the collection area as the origin, the position parameters of the target feature point may be determined in the following manner, but not limited to the following descriptions.
At S21, the position parameters of pixel points in the second image corresponding to the target feature point in the second image are determined, and the position parameters of the pixel points corresponding to the target feature point in the second image are determined as the position parameters of the target feature point.
At S22, the position set corresponding to the target trajectory may be determined in the following manner, but not limited to the following manner.

Starting timing from the starting point of the target trajectory, a position corresponding to the target trajectory may be calculated once every collection time interval until the timing duration reaches the collection duration. For example, when the target trajectory is a target spiral line, the positions may be calculated based on the following formula: x=r*cos(t) and y=r*sin(t), where x and y represent the position, r represents the radius of the target spiral line, t represents the time point, and the time point is the time determined every collection time interval starting from the starting point of the target spiral line.

Corresponding to the second image, the target position may be the position corresponding to the target trajectory calculated at one collection time interval starting from the starting point of the target trajectory in the position set corresponding to the target trajectory.

It may be understood that if the position parameters of the target feature point do not correspond to the target position in the position set corresponding to the target trajectory, the second image may not be used as a target collected image.

In this embodiment, based on the fixed collection area, by collecting the first image and the second image, it may be determined whether the second image includes the target feature point that is the same as the first reference feature point of the first image, to determine whether the operation body is moving relative to the collection area. When the operation body is moving relative to the collection area, it may be further determined whether the position parameters of the target feature point correspond to the target position in the position set corresponding to the target trajectory, to determine whether the second image matches the target trajectory and determine whether the second image may be used as a target collected image to expand the target collected images.

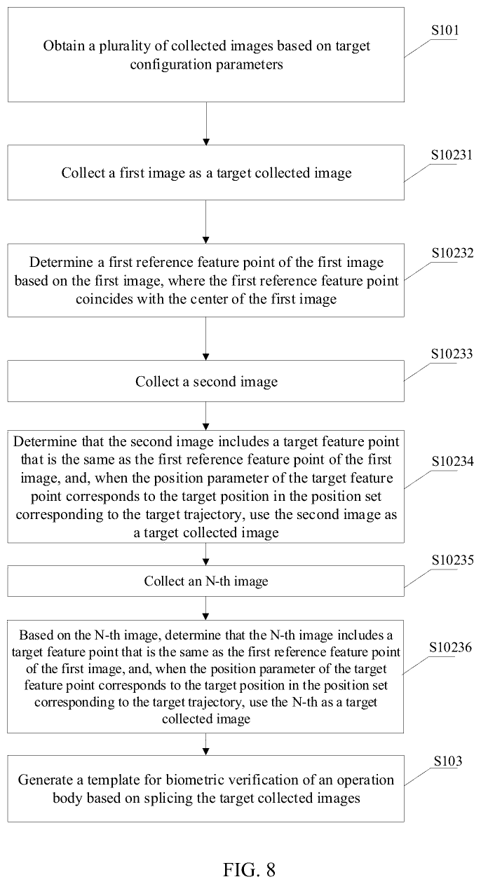

In another embodiment shown in FIG. 8, S1023 may include, but is not limited to, S10231 to S10236.

At S10231, the first image is collected as a target collected image.

At S10232, the first reference feature point of the first image is determined based on the first image, and the first reference feature point coincides with the center of the first image.

At S10233, the second image is collected.

At S10234, that the second image includes the target feature point that is the same as the first reference feature point of the first image is determined based on the second image; and, when the position parameters of the target feature point correspond to the target position in the position set corresponding to the target trajectory, the second image is used as a target collected image.

At S10235, an N-th image is collected, where N is an integer greater than 2.

In one embodiment, the above-mentioned method of collecting the second image may be used to collect the N-th image, which will not be repeated here.

At S10236, that the N-th image includes a target feature point that is the same as the first reference feature point of the first image is determined based on the N-th image, and, when the position parameters of the target feature point correspond to the target position in the position set corresponding to the target trajectory, the N-th image is used as a target collected image.

When the N-th image is collected, the first reference feature point of the first image may be still used as a reference to determine whether the N-th image includes the target feature point that is the same as the first reference feature point of the first image. When the N-th image includes the target feature point that is the same as the first reference feature point of the first image, it may be still possible to determine whether the operation body is moving according to the target trajectory based on the position change of the first reference feature point relative to the collection area. For example, it may be possible to determine whether the position parameters of the target feature point correspond to the target position in the position set corresponding to the target trajectory. If they correspond, it may be determined that the operation body is moving according to the target trajectory.

The target position may be the position corresponding to the target trajectory calculated from the starting point of the target trajectory in the position set corresponding to the target trajectory at (N−1) collection time intervals.

In this embodiment, the method of determining the position parameters of the target feature point in previous embodiments may be used to determine the position parameters of the target feature point in the N-th image that is the same as the first reference feature point of the first image, which will not be repeated here.

In this embodiment, when the N-th image includes the target feature point that is the same as the first reference feature point of the first image, it may be still possible to determine whether the operation body is moving along the target trajectory based on the position change of the first reference feature point relative to the collection area. When the operation body is moving along the target trajectory, the N-th image may be used as a target collected image to expand the target collected images.

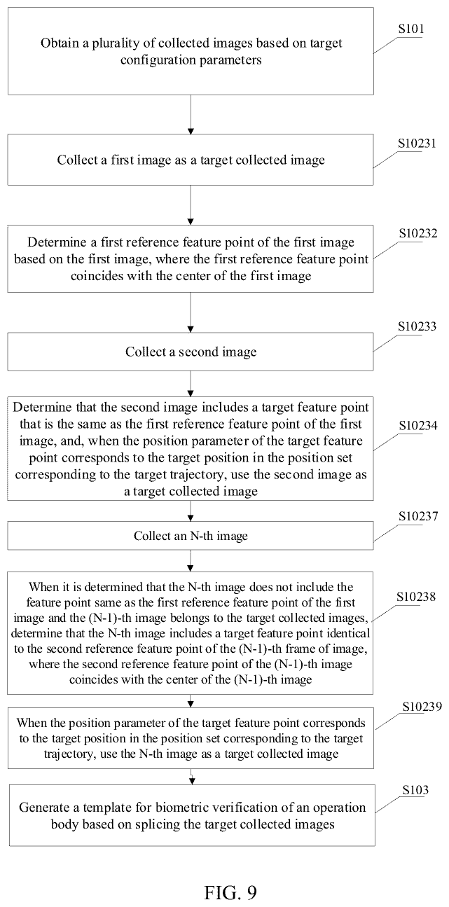

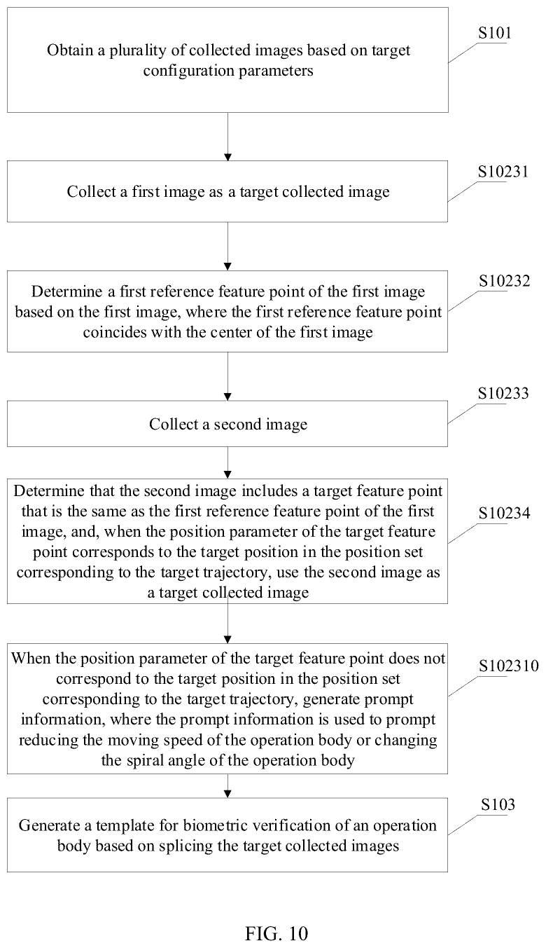

In another embodiment shown in FIG. 9, S1023 may include, but is not limited to, S10231 to S10234, and S102137 to S10239.

At S10231, the first image is collected as a target collected image.

At S10232, the first reference feature point of the first image is determined based on the first image, and the first reference feature point coincides with the center of the first image.

At S10233, the second image is collected.

At S10234, that the second image includes the target feature point that is the same as the first reference feature point of the first image is determined based on the second image; and, when the position parameters of the target feature point corresponds to the target position in the position set corresponding to the target trajectory, the second image is used as a target collected image.

At S10237, an N-th image is collected, where N is an integer greater than 2.

In one embodiment, the above-mentioned method of collecting the second image may be used to collect the N-th image, which will not be repeated here.

At S10238, when it is determined that the N-th image does not include the same feature point as the first reference feature point of the first image and the (N−1)-th image belongs to the target collected images, it is determined that the N-th image includes the target feature point that is the same as the second reference feature point of the (N−1)-th image, and the second reference feature point of the (N−1)-th image coincides with the center of the (N−1)-th image.

When it is determined that the N-th image does not include the same feature point as the first reference feature point of the first image, it may be necessary to determine a new comparison image for the N-th image. In one embodiment, the (N−1)-th image may be selected as a new comparison image to determine whether the N-th image belongs to the target collected images.

The (N−1)-th image may belong to the target collected images, which may be understood as: the position parameters of the feature point in the (N−1)-th image correspond to the target position in the position set corresponding to the target trajectory. The target position corresponding to the position parameters of the feature point in the (N−1)-th image may be the position corresponding to the target trajectory calculated from the starting point of the target trajectory in the position set corresponding to the target trajectory and separated by N−2 collection time intervals; or, the position corresponding to the starting point of the target trajectory in the position set corresponding to the target trajectory.

When it is determined that the (N−1)-th image belongs to the target collected images, it may be determined whether the N-th image includes the target feature point that is the same as the second reference feature point of the (N−1)-th image. When the N-th image includes the target feature point that is the same as the second reference feature point of the (N−1)-th image, it may be determined that the operation body is moving relative to the collection area.

At S10239, when the position parameters of the target feature point correspond to the target position in the position set corresponding to the target trajectory, the N-th image is used as a target collected image.

In one embodiment, whether the operation body is moving according to the target trajectory may be determined based on the position change of the second reference feature point relative to the collection area. For example, whether the position parameters of the target feature point in the N-th image that is the same as the second reference feature point of the (N−1)-th image correspond to the target position in the position set corresponding to the target trajectory may be determined. If they correspond, it may be determined that the operation body is moving according to the target trajectory.

In one embodiment, the method of determining the position parameter of the target feature point in previous embodiments may be used to determine the position parameters of the target feature point in the N-th image that is the same as the second reference feature point of the (N−1)-th image, which will not be repeated here.

In one embodiment, the target position may be the position corresponding to the target trajectory calculated at (N−1) collection time intervals from the starting point of the target trajectory in the position set corresponding to the target trajectory.

In this embodiment, when it is determined that the N-th image does not include the same feature point as the first reference feature point of the first image, whether the (N−1)-th image belongs to the target collected image may be determined to determine a new reference feature point. When the (N−1)-th image belongs to the target collected images, the second reference feature point in the (N−1)-th image may be used as a new reference feature point to determine whether the N-th image includes the target feature point that is the same as the second reference feature point of the (N−1)-th image, and continue to perform position comparison. When the N-th image includes the target feature point that is the same as the second reference feature point of the (N−1)-th image, whether the position parameters of the target feature point correspond to the target position in the position set corresponding to the target trajectory may be determined, to determine whether the N-th image is used as a target collected image to expand the target collected images.

In another embodiment shown in FIG. 9, S1023 may include, but is not limited to, S10231 to S10234, and S102310.
At S10231, the first image is collected as a target collected image.
At S10232, the first reference feature point of the first image is determined based on the first image, and the first reference feature point coincides with the center of the first image.
At S10233, the second image is collected.
At S10234, that the second image includes the target feature point that is the same as the first reference feature point of the first image is determined based on the second image; and, when the position parameters of the target feature point corresponds to the target position in the position set corresponding to the target trajectory, the second image is used as a target collected image.
At S102310, when the position parameter of the target feature point does not correspond to the target position in the position set corresponding to the target trajectory, a prompt message is generated, and the prompt message is used to provide at least one of the following: reducing the moving speed of the operation body or changing the spiral angle of the operation body.

When the position parameter of the target feature point does not correspond to the target position in the position set corresponding to the target trajectory, corresponding to the implementation where the collection area is fixed and the coordinate system is established based on the center point of the collection area as the origin, the first distance between the target feature point and the origin may be determined based on the position parameter of the target feature point, and the second distance between the target position in the position set corresponding to the target trajectory and the origin may be also determined. When the first distance is larger than the second distance, the operation body may be determined to move too fast, and a prompt message for reducing the moving speed of the operation body may be generated.

When the position parameter of the target feature point does not correspond to the target position in the position set corresponding to the target trajectory, corresponding to the implementation where the collection area is fixed and the coordinate system is established based on the center point of the collection area as the origin, a first angle between the target feature point and the origin based on the position parameter of the target feature point, and the second angle between the target position in the position set corresponding to the target trajectory and the origin, may be determined. Based on the offset between the first angle and the second angle, a prompt message for changing the spiral angle of the operation body may be generated.

In the present disclosure, when the position parameters of the target feature point do not correspond to the target position in the position set corresponding to the target trajectory, the prompt message may be generated to guide the operation body to move according to the target trajectory, such that the collection device is able to obtain a plurality of collected images that meet the clarity condition within the collection duration, and the areas corresponding to the plurality of collected images that meet the clarity conditions are not less than the specified area corresponding to the operation body, thereby improving the efficiency of template generation and ensuring the quality of the template.

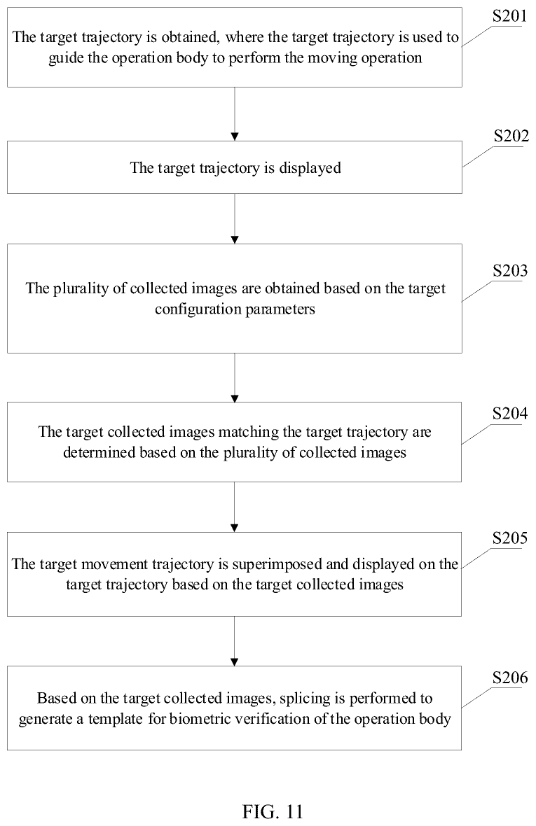

In another embodiment shown in FIG. 11, the collection method may include, but is not limited to S201 to S206.

At S201, the target trajectory is obtained, where the target trajectory is used to guide the operation body to perform the moving operation.

At S202, the target trajectory is displayed.

In one embodiment, the target trajectory may be displayed in the biometric feature entry interface, and the starting point of the target trajectory may coincide with the center point of the collection area.

The user may refer to the displayed target trajectory to control the movement of the operation body relative to the collection area.

At S203, the plurality of collected images are obtained based on the target configuration parameters. The plurality of collected images may be used to characterize the movement trajectory of the operation body covering the collection area of the collection device. The collection area may be smaller than the operation body, and the target configuration parameters, when applied to the collection device, may enable the collection device to enable the collection device to obtain images that meet the clarity condition when the operation body moves.

For the detailed process of S203, references may be made to the relevant description of S101 in the previous embodiments, which will not be repeated here.

At S204, the target collected images matching the target trajectory are determined based on the plurality of collected images, and the target movement trajectory represented by the target collected images matches the target trajectory.

For the detailed process of S204, references may be made to the relevant description of S1023 in the previous embodiments, which will not be repeated here.

At S205, the target movement trajectory is superimposed and displayed on the target trajectory based on the target collected images.

When the target movement trajectory is superimposed and displayed on the target trajectory based on the target collected images, it may be necessary to distinguish between the target trajectory and the target movement trajectory. For example, it may be possible but not limited to weaken the display of the target trajectory and highlight the display of the target movement trajectory, such that the target trajectory and the target movement trajectory are able to be distinguished when the target movement trajectory is superimposed and displayed on the target trajectory.

By executing S205, the user may be able to observe the degree of matching between the target trajectory and the target movement trajectory, and adjust the movement of the operation body more specifically, such that the operation body may better move according to the target trajectory.

At S206, based on the target collected images, splicing is performed to generate a template for biometric verification of the operation body.

For the detailed process of S206, references may be made to the relevant description of S103 in the previous embodiments, which will not be repeated here.

In some other embodiments, S201-S202 may also be performed after S204. For example, when it is determined at S204 that collected images in the plurality of collected images do not match the target trajectory, S201-S202 may be performed.

In this embodiment, by obtaining the target trajectory and displaying the target trajectory, the operation body may be guided to perform a moving operation, and the target movement trajectory may be superimposed and displayed on the target trajectory based on the target collected images, such that the user is able to observe the matching degree between the target trajectory and the target movement trajectory to adjust the movement of the operation body in a more targeted manner. Therefore, the operation body may better move according to the target trajectory, further improving the user experience.

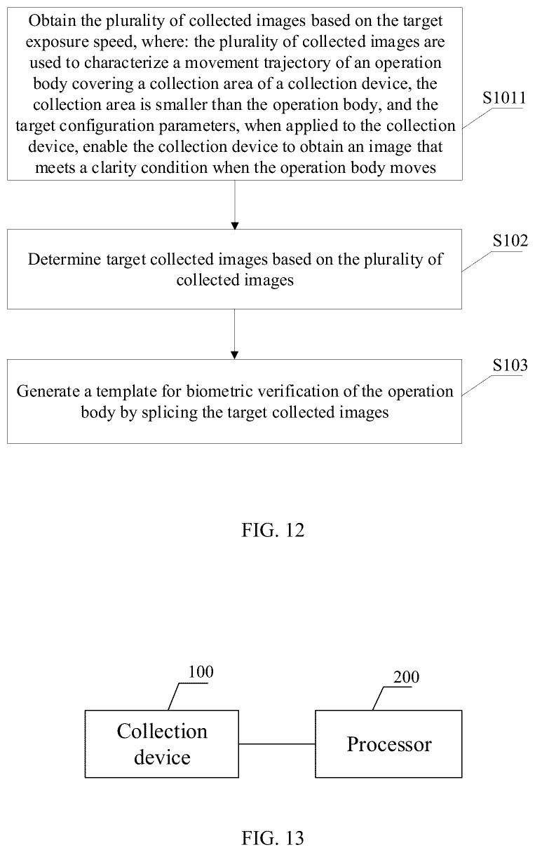

In one embodiment shown in FIG. 12, S101 may include, but is not limited to:
S1011: obtaining the plurality of collected images based on the target exposure speed. The plurality of collected images may be used to characterize the movement trajectory of the operation body covering the collection area of the collection device. The collection area may be smaller than the operation body, and the target configuration parameters, when applied to the collection device, may enable the collection device to obtain images that meet the clarity condition when the operation body moves.

In this embodiment, the method for making the exposure speed of the collection device reach the target exposure speed may include, but is not limited to, increasing the capture area from the first brightness value to the second brightness value. The target exposure speed may be faster than the exposure speed of the collection device corresponding to the first brightness value of the capture area. Based on the faster exposure speed, more collected images may be collected at the same time.

The present disclosure also provides a collection device. The collection device may include a collection area and a collection component.

The collection component may be configured to collect images based on the target configuration parameters, to obtain the plurality of collected images. The plurality of collected images may be used to characterize the movement trajectory of the operation body covering the collection area of the collection device. The collection area may be smaller than the operation body, and the target configuration parameters, when applied to the collection device, may enable the collection device to obtain images that meet the clarity condition when the operation body moves.

The collection area may include, but is not limited to, photosensitive elements. Correspondingly, the collection component may include, but is not limited to, a fingerprint sensor.

The present disclosure also provides an electronic device. The electronic device may perform any collection method provided by various embodiments of the present disclosure.

As shown in FIG. 13, the electronic device includes a collection device 100 and a processor 200.

The collection device 100 may be configured to collect images based on the target configuration parameters, to obtain the plurality of collected images.

The processor 200 may be configured to:
obtain the plurality of collected images based on the target configuration parameters, where the plurality of collected images may be used to characterize the movement trajectory of the operation body covering the collection area of the collection device, the collection area may be smaller than the operation body, and the target configuration parameters, when applied to the collection device, may enable the collection device to obtain images that meet the clarity condition when the operation body moves;
determine target collected images based on the plurality of collected images; and
generate a template for biometric verification of an operation body based on splicing the target collected images.

In one embodiment, when being configured to determine the target collected images based on the plurality of collected images, the processor 200 may be configured to:
determine the target collected images that match the target trajectory based on the plurality of collected images, where the target movement trajectory represented by the target collected images matches the target trajectory.

In one embodiment, when determining the target collected images that match the target trajectory based on the plurality of collected images, the processor 200 may be configured to:
collect a first image as a target collected image;
determine a first reference feature point of the first image based on the first image, where the first reference feature point coincides with the center of the first image;
collect a second image;
determine whether the second image includes the target feature point that is the same as the first reference feature point of the first image based on the second image, and, when the position parameter of the target feature point corresponds to the target position in the position set corresponding to the target trajectory, use the second image as a target collected image.

In one embodiment, when determining the target collected images that match the target trajectory based on the plurality of collected images, the processor 200 may be further configured to:
collect an N-th image;
based on the N-th image, determine the target feature point that is the same as the first reference feature point of the first image and included in the N-th image, and, when the position parameter of the target feature point corresponds to the target position in the position set corresponding to the target trajectory, use the N-th image as a target collected image.

In one embodiment, when determining the target collected images that match the target trajectory based on the plurality of collected images, the processor 200 may be further configured to:
collect the N-th image;
when it is determined that the N-th image does not include the feature point same as the first reference feature point of the first image and the (N−1)-th image belongs to the target collected images, determine that the N-th image includes a target feature point identical to the second reference feature point of the (N−1)-th image, where the second reference feature point of the (N−1)-th image coincides with the center of the (N−1)-th image; and
when the position parameter of the target feature point corresponds to the target position in the position set corresponding to the target trajectory, use the N-th image as a target collected image.

In one embodiment, the processor 200 may be further configured to:
when the position parameter of the target feature point does not correspond to the target position in the position set corresponding to the target trajectory, generate prompt information, where the prompt information is used to provide at least one of the following: reducing the moving speed of the operation body or changing the spiral angle of the operation body.

In one embodiment, the processor 200 may be further configured to:
obtain the target trajectory, where the target trajectory is used to guide the operation body to perform the moving operation;
display the target trajectory;
superimpose and display the target movement trajectory on the target trajectory based on the target collected images.

In one embodiment, the processor 200 may be further configured to:
determine the collection duration corresponding to the collection device based on the specified area corresponding to the operation body and the target configuration parameters, wherein, within the collection duration, the area corresponding to the plurality of collected images collected by the collection device is not less than the specified area and the plurality of collected images meet the clarity conditions; and
determine the target trajectory based on the collection duration, the specified area and the specified shape parameters.

In some embodiments, an electronic device consistent with the disclosure may include a collection device, at least one processor, and at least one memory storing one or more instructions that, when executed by the at least one processor, causes the electronic device to perform a method consistent with the disclosure.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the other element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

In this disclosure, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: a plurality of units or components may be combined, or may be integrated into another system, or some features may be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to a plurality of network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units may be integrated into one unit. The above-mentioned integration units may be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that may store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that may store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A collection method comprising:
obtaining, through a collection area of a collection device, a plurality of collected images based on one or more target configuration parameters, the one or more target configuration parameters, when applied to the collection device, enabling the collection device to obtain an image that meets a clarity condition when an operation body moves in the collection area;
determining target collected images based on the plurality of collected images; and
generating a template for biometric verification of the operation body by splicing the target collected images.

2. The method according to claim 1, wherein determining the target collected images includes:
determining two or more of the plurality of collected images that represent a target movement trajectory matching a target trajectory as the target collected images.

3. The method according to claim 2, wherein determining the two or more of the plurality of collected images as the target collected images includes:
determining a first image of the plurality of collected images as one of the target collected images;
determining a reference feature point of the first image, the reference feature point coinciding with a center of the first image;
determining that a second image of the plurality of collected images includes a target feature point same as the reference feature point; and
in response to a position parameter of the target feature point corresponding to a target position in a position set corresponding to the target trajectory, determining the second image as another one of the target collected images.

4. The method according to claim 3, wherein:
the target feature point is a first target feature point; and
determining the two or more of the plurality of collected images as the target collected images further includes:
determining that an N-th image of the plurality of collected images includes a second target feature point same as the reference feature point, N being an integer greater than 2; and
in response to a position parameter of the second target feature point corresponding to the target position in the position set, determining the N-th image as a further one of the target collected images.

5. The method according to claim 3, wherein:
the reference feature point is a first reference feature point and the target feature point is a first target feature point; and
determining the two or more of the plurality of collected images as the target collected images further includes:
in response to determining that an N-th image of the plurality of collected images does not include a target feature point same as the reference feature point and the target collected images including an (N−1)-th image, determining that the N-th image includes a second target feature point same as a second reference feature point of the (N−1)-th image, the second reference feature point coinciding with a center of the (N−1)-th image; and
in response to a position parameter of the second target feature point corresponding to the target position in the position set, determining the N-th image as a further one of the target collected images.

6. The method according to claim 3, further comprising:
in response to the position parameter of the target feature point not corresponding to the target position in the position set, generating prompt information, the prompt information including at least one of reducing a moving speed of the operation body or changing a spiral angle of the operation body.

7. The method according to claim 2, further comprising:
obtaining the target trajectory;
displaying the target trajectory; and
superimposing and displaying the target movement trajectory on the target trajectory based on the target collected images.

8. The method according to claim 7, further comprising:
based on a designated area corresponding to the operation body and the one or more target configuration parameters, determining a collection duration corresponding to the collection device, during which an area corresponding to the plurality of collected images collected by the collection device is not less than the designated area and the plurality of collected images meet the clarity condition; and
based on the collection duration, the designated area, and one or more designated shape parameters, determining the target trajectory.

9. The method according to claim 1, wherein obtaining the plurality of collected images includes:
obtaining the plurality of collected images in response to the operation body moving in the collection area along a spiral line.

10. A collection device comprising:
a collection area; and
a collection component configured to obtain a plurality of collected images based on one or more target configuration parameters, the one or more target configuration parameters, when applied to the collection device, enabling the collection device to obtain an image that meets a clarity condition when an operation body moves in the collection area.

11. An electronic device comprising:
a collection device; and
a processor configured to:
configure the collection device based on one or more target configuration parameters to obtain a plurality of collected images, the one or more target configuration parameters, when applied to the collection device, enabling the collection device to obtain an image that meets a clarity condition when an operation body moves in the collection area;
determine target collected images based on the plurality of collected images; and
generate a template for biometric verification of the operation body by splicing the target collected images.

12. The electronic device according to claim 11, wherein the processor is further configured to, when determining the target collected images:
determine two or more of the plurality of collected images that represent a target movement trajectory matching a target trajectory as the target collected images.

13. The electronic device according to claim 12, wherein the processor is further configured to, when determining the two or more of the plurality of collected images as the target collected images:
determine a first image of the plurality of collected images as one of the target collected images;
determine a reference feature point of the first image, the reference feature point coinciding with a center of the first image;
determine that a second image of the plurality of collected images includes a target feature point same as the reference feature point; and
in response to a position parameter of the target feature point corresponding to a target position in a position set corresponding to the target trajectory, determine the second image as another one of the target collected images.

14. The electronic device according to claim 13, wherein:
the target feature point is a first target feature point; and
the processor is further configured to, when determining the two or more of the plurality of collected images as the target collected images:
determine that an N-th image of the plurality of collected images includes a second target feature point same as the reference feature point, N being an integer greater than 2; and
in response to a position parameter of the second target feature point corresponding to the target position in the position set, determine the N-th image as a further one of the target collected images.

15. The electronic device according to claim 13, wherein:
the reference feature point is a first reference feature point and the target feature point is a first target feature point; and
the processor is further configured to, when determining the two or more of the plurality of collected images as the target collected images:
in response to determining that an N-th image of the plurality of collected images does not include a target feature point same as the reference feature point and the target collected images including an (N−1)-th image, determine that the N-th image includes a second target feature point same as a second reference feature point of the (N−1)-th image, the second reference feature point coinciding with a center of the (N−1)-th image; and
in response to a position parameter of the second target feature point corresponding to the target position in the position set, determine the N-th image as a further one of the target collected images.

16. The electronic device according to claim 13, wherein the processor is further configured to:
in response to the position parameter of the target feature point not corresponding to the target position in the position set, generate prompt information, the prompt information including at least one of reducing a moving speed of the operation body or changing a spiral angle of the operation body.

17. The electronic device according to claim 12, wherein the processor is further configured to:
obtain the target trajectory;
display the target trajectory; and
superimpose and display the target movement trajectory on the target trajectory based on the target collected images.

18. The electronic device according to claim 17, wherein the processor is further configured to:
based on a designated area corresponding to the operation body and the one or more target configuration parameters, determine a collection duration corresponding to the collection device, during which an area corresponding to the plurality of collected images collected by the collection device is not less than the designated area and the plurality of collected images meet the clarity condition; and
based on the collection duration, the designated area, and one or more designated shape parameters, determine the target trajectory.

19. The electronic device according to claim 11, wherein the processor is further configured to, when configuring the collection device to obtain the plurality of collected images:
configure the collection device to obtain the plurality of collected images in response to the operation body moving in the collection area along a spiral line.
